(19) United States
(12) Patent Application Publication
(10) Pub. No.: US 2005/0211068 A1
(43) Pub. Date: Sep. 29, 2005

(54) Method and apparatus for making music and article of manufacture thereof

(76) Inventor: Jonathan David Zar, Berkeley, CA (US)

Correspondence Address: JONATHAN ZAR, 1303 McGee AVENUE, BERKELY, CA, 94703, US

(21) Appl. No.: 10/990,832

(22) Filed: Nov. 16, 2004

Related U.S. Application Data
(60) Provisional application No. 60/520,976, filed on Nov. 18, 2003.

(51) Int. Cl. G10H 1/00; A63H 5/00; G10H 7/00; G04B 13/00

(52) U.S. Cl. 84/600

(57) ABSTRACT

A method, apparatus and article of manufacture for making music with any physical or virtual object, including any article of manufacture or object of nature, wherein one or more sensors communicate with a synthesizer or other signal processing device. The sensors may be in any physical arrangement to the object being played including remote from such object. The object which is played may be physical or virtual. In one embodiment the communication means is a wireless network, the synthesizer is small and portable and the played object is portable, ergonomic and of a non-traditional industrial design. In another embodiment the played object is mobile phone.

### RELATED PROVISIONAL FILING

Provisional Application of inventor Jonathan Zar deposited on Nov. 16, 2003 via pre-paid United States Express Mail, item EU 972802964 US, and subsequently designated by the Commissioner for Patents as item 17510 U.S. PTO 60/520,976 of Nov. 18, 2003.

### FIELD OF INVENTION

This invention relates generally to the field of music and, more particularly, to a Method and Apparatus for Making Music.

### BACKGROUND OF THE INVENTION

This invention is inspired by the work of Lou Harrison and William Colvig in building novel acoustic gamelans [gamelons typo]. My wife Eileen Zar met Mr. Harrison when we lived in Santa Cruz and it was through her mention that I first became aware of his work. After listening to several of his symphonies I was reminded that I love the sound of gamelan and the feeling it evoked for me from travel films (see “Ring of Fire” An Indonesian Odyssey—The Ten Year Voyage of Brothers Lorne and Lawrence Blair”) and so I became curious about the inventive work that Mssrs. Harrison and Colvig applied to creating their own instruments. When we moved to Berkeley I began to listen to some recorded interviews of Lou Harrison and was struck by a particular interview with him and William Colvig that Gamelan was a kind of community orchestra. I also became curious about this time with the sound of the band Ladytron and other electronic/electroclash bands, in particular with the ease by which musicians armed with personal computers could make music without prior training in classical instruments.

Subsequently and moved by the tragic events of 11 Sep. 2001 I realized that my own desire was to find some means to reawaken a creative, dynamic and constructive impulse in the larger community and myself. I felt that the spirit in Gamelan was the right approach and I saw something of that in Ladytron and the related bands. Making music, rather than just listening to it, would be a great way for people to build trust and connection.

From my experience leading the Chefcat project at Apple, I was acquainted with both the process by which new consumer products can be created and the significance of designs which enable a latent need in youth culture.

To that end I began to ask myself what would I want if I were starting a band, and quickly the pieces fell into place.

I realized that traditional musical instruments are in the form required for acoustic resonance, whether they were percussive, string, wind or otherwise. And in this form they are often physically demanding to play requiring a high level of skill before music can be made, they are often not portable (indeed sometimes quite heavy or large) they don't network, they are expensive, they often require tuning or cleaning, and in general they present multiple market barriers to adoption. Which is why the number of listeners is higher than players who perform music. I also realized that electronic instruments are very limited in form today. They are wired, they still require a high level of skill to play and surprisingly they are not networked and are almost always in the historic form of a traditional earlier acoustic musical instruments, as for example: the electric guitar, the electric violin, the electric oboe, the electric organ or the electric drum kit. While these are all wonderful instruments, they represent very constrained designs. Good time tested designs, but designs which are based on assumptions that no longer need apply.

Musical instruments are limited in form.

Even if they contain digital electronics, they generally look like traditional instruments with comparable physical dimensions and weight.

They require significant skill to play.

Most are of limited portability. With the exception of the harmonica and mouth harp almost nothing fits in a pocket.

If they are electronic they are either monolithic like an organ or tethered to an amplifier like a guitar, again not portable.

If they are amplified or otherwise electric, their parts connect via cables. They are not wireless. Again not portable.

They are rigid in their musical expressiveness. If they are acoustic they have a very specific voice and range.

In general today's musical instruments are not adaptive to their player, not adaptive to the composition being performed and not adaptive to their environment.

They do not network and are not optimized or designed to enhance people's ability to play in ensemble.

It is therefore an object of the invention to make musical instruments more portable.

It is another object of the invention to make musical instruments more ergonomic.

It is another object of the invention to make musical instruments more varied in form or design.

It is another object of the invention to make it easier and/or more fun to play music by reducing the physical difficulty or dexterity of playing.

It is another object of the invention is to make it easier and/or more fun to play music by reducing the mental difficulty of playing.

Another object of the invention is to free musical instruments from physical forms with elements that resonate, vibrate, or otherwise have an acoustic function.

A further object of the invention is to free musical instruments from physical forms historically originating from an acoustic function.

Yet another object of the invention is to make it easier to play music with others in a group, whether the group is networked, ad-hoc, or otherwise.

Another object of the invention is to increase the kinds of instruments people play together in any kind of group such as a bands, ensembles, orchestras and gamelans.

Another object of the invention is to make it easier to interact as a composer with machines, ones-self and/or other people.

A further object of the invention is generally, to make music creation, playing and/or performance as popular in the future as music listening is today.

Yet another object of the invention is to commence a new movement of industrial design in performance arts.

Primary Elements:

played_object, consisting of any object, sculpture or other thing, including any natural, artificial or virtual thing, or any combination of such things

played_object_sensor, consisting of any kind of sensor associated with a played_object, whether or not attached to the played_object

played_object_transmitter, consisting of any means for transmitting the state, signal and/or value of one or more played_object_sensors

consig_unit, consisting of any means for controlling, synthesizing, splitting, muxing, filtering or otherwise processing the state, signal and/or value of one or more played_object_sensors

Optional Elements:

consig_unit_transceiver, consisting of any means for communicating between any combination of one or more of the following: a played_object, a consig_unit, a listening_unit

listening_unit, consisting of any means of listening to the raw and/or processed state, signal and/or values of one or more played_object_sensors for one or more played_objects

As can be seen, a played_object includes items of nature, whether living or not and whether modified or not, artifacts or articles of manufacture, any object of art or design, virtual objects without regard to their method of virtualization and anything consisting of any combination of the above

As can be seen, a played_object_sensor may be in any physical relation to a played_object including but not limited to any of the following: through, under, beneath, around, over, about, in, contained, embedded within, incorporated [incorporate: typo], over, embracing, containing, on, above, lateral, side-ways, under, attached, unattached, applied, unapplied, near, proximate, far, remote, adjacent, not adjacent

Secondary Elements:

The association of a played_object_sensor by attachment, application, incorporation, embedding or other association means

The association of a played_object_sensor by logical addressing

The association of a played_object_sensor through any imposition of virtual forms, as through projection, or by any other indirect, virtual or remote method

The association of a played_object sensor by any combination of physical proximity, logical addressing, and/or virtual, indirect or remote methods

The combination and/or integration of a played_object and a played_object_transmitter

The combination and/or integration of a consig_unit and a consig_unit_transceiver

The combination and/or integration of a consig_unit and a listening_unit

The combination and/or integration of a consig_unit, consig_unit_transceiver and listening_unit

The combination and/or integration of a consig_unit, consig_unit_transceiver, listening_unit and played_object

The combination and/or integration of a played_object_transmitter and a consig_unit_transceiver

The embodiment of a listening_unit as a headphone jack and related circuitry

The embodiment of a listening_unit as a speaker

The embodiment of a listening_unit as a wireless earbud, earbuds, earpiece, earpieces, earphone, earphones, headset, headphone, headphones, or any other apparatus worn in, within, on, about or proximate to the ears, head or neck

The embodiment of a listening_unit as a Bluetooth earpiece or other wireless earbud, earbuds, earpiece, earpieces, earphone, earphones, headset, headphone, headphones, or any other apparatus worn in, within, on, about or proximate to the ears, head or neck

The embodiment of a listening_unit as any earpiece or other wireless earbud, earbuds, earpiece, earpieces, earphone, earphones, headset, headphone, headphones, or any other apparatus worn in, within, on, about or proximate to the ears, head or neck

The embodiment of a listening_unit using any form of wired or wireless communication including without limitation CDMA, GSM, any form of wireless Ethernet, wireless USB, wired and wireless forms of 1394, infra-red, near-field communication, ultra wide band communication, subsonic, sonic and ultrasonic communication

The embodiment of a listening_unit using any form of wired or wireless communication with any protocol or standard, whether wireless, wired or otherwise, including any combination of protocols or standards sponsored, developed, proposed, promulgated and/or approved by any private or public corporation, private or public consortium, the IEEE, ANSI, ITU, IEC, INCITS, TIA, EIA, JEDEC, ISO or any other public or private standards organization, body or group

The embodiment of a listening_unit using any form of wired or wireless communication known today or hereafter discovered

The embodiment of a consig_unit as any portable device

The embodiment of a consig_unit as a portable consumer electronic device

The embodiment of a consig_unit as a mobile phone

The embodiment of a consig_unit as a watch

The embodiment of a consig_unit as a pen

The embodiment of a consig_unit as a purse

The embodiment of a consig_unit as a wallet

The embodiment of a consig_unit as any item of clothing, jewelry or other items worn on or about a person

The control of a consig_unit by one or more played_objects

A played_object which is a consig_unit

A sensor_article, consisting of one more played_object_sensors as a component for attachment, application, incorporation or embedding into a played_object

A played_object_article, consisting of a played_object as a component for attachment, application, incorporation or embedding into a larger played_object

The embodiment of a played_object as a sculpture or other object of art or design

The embodiment of a played_object as any article of manufacture

The embodiment of a played_object as a living being

The embodiment of a played_object as a natural object

The embodiment of a played_object as a virtual object

The embodiment of a played_object as a form of a known musical instrument

The embodiment of a played_object as new form of musical instrument

The embodiment of a played_object as any combination of the foregoing

The networking of one or more played_objects and/or consig_units

The addition of any method of storage and retrieval to a consig_unit

Subtitute Elements:

The use of any material with any physical property that varies under any tactile or other sensory, physical or environmental change as a played_object_sensor

The use of any means for sensing interactions with a played_object as played_object_sensor

The substitution of a played_object_transmitter with a wired bus

The substitution of a played_object_transmitter with a wired link

The substitution of a played_object_transmitter with a wired network

The substitution of a played_object_transmitter with a wireless bus

The substitution of a played_object_transmitter with a wireless link

The substitution of a played_object_transmitter with a wireless network

The substitution of a played_object_transmitter with any wireless interface

The substitution of a played_object_transmitter with any 802.X wireless interface, protocol, or other form of any wireless Ethernet

The substitution of a played_object_transmitter with any Bluetooth wireless interface, protocol or form of Bluetooth

The substitution of a played_object_transmitter with any IEEE protocol or standard, whether wireless, wired or otherwise

The substitution of a played_object_transmitter with any CDMA wireless interface, protocol or form of CDMA

The substitution of a played_object_transmitter with any GSM wireless interface, protocol or form of GSM

The substitution of a played_object_transmitter with any USB wireless interface, protocol or form of USB

The substitution of a played_object_transmitter with any IEEE 1394 wireless interface, protocol or form of 1394

The substitution of a played_object transmitter with any ultra wide band interface, protocol or form of ultra wide band

The substitution of a played_object_transmitter with any narrow band interface, protocol or form of narrow band

The substitution of a played_object transmitter with any near-field wireless interface, protocol or form of near-field

The substitution of a played_object transmitter with any sonic, subsonic or ultrasonic interface, protocol or form of sonic, subsonic or ultrasonic signaling

The substitution of a played_object_transmitter with any Zigbee interface or form of Zigbee

The substitution of a played_object_transmitter [played_object_transmiter: typo] with any optical interface, protocol or form of light signaling, whether ambient or not, including infra-red

The substitution of a played_object_transmitter with any other form of any other wireless interface or protocol, whether presently known or hereafter created

The substitution of a played_object_transmitter with any protocol or standard, whether wireless, wired or otherwise, including any combination of protocols or standards

The substitution of a played_object_transmitter with any protocol or standard, whether wireless, wired or otherwise, including any combination of protocols or standards sponsored, developed, proposed, promulgated and/or approved by any private or public corporation, private or public consortium, the IEEE, ANSI, INCITS, ITU, IEC, TIA, EIA, JEDEC, ISO or any other public or private standards organization, body or group

The substitution of a consig_unit_transceiver with a wired bus

The substitution of a consig_unit_transceiver with a wired link

The substitution of a consig_unit_transceiver with a wired network

The substitution of a consig_unit_transceiver with a wireless bus

The substitution of a consig_unit_transceiver with a wireless link

The substitution of a consig_unit_transceiver with a wireless network

The substitution of a consig_unit_transceiver with any wireless interface

The substitution of a consig_unit_transceiver with any 802.X wireless interface, protocol, or other form of any wireless Ethernet

The substitution of a consig_unit_transceiver with any Bluetooth wireless interface, protocol or form of Bluetooth

The substitution of a consig_unit_transceiver with any IEEE protocol or standard, whether wireless, wired or otherwise

The substitution of a consig_unit_transceiver with any CDMA wireless interface, protocol or form of CDMA

The substitution of a consig_unit_transceiver with any GSM wireless interface, protocol or form of GSM

The substitution of a consig_unit_transceiver with any USB wireless interface, protocol or form of USB

The substitution of a consig_unit_transceiver with any IEEE 1394 wireless interface, protocol or form of 1394

The substitution of a played_object transmitter with any ultra wide band interface, protocol or form of ultra wide band

The substitution of a played_object transmitter with any narrow band interface, protocol or form of narrow band

The substitution of a consig_unit_transceiver with any near-field wireless interface, protocol or form of near-field

The substitution of a consig_unit_transceiver with any sonic, subsonic or ultrasonic wireless interface, protocol or form of sonic, subsonic or ultrasonic signaling

The substitution of a consig_unit_transceiver with any Zigbee interface or form of Zigbee

The substitution of a consig_unit_transceiver [played_object_transmiter: typo] with any optical interface, protocol or form of light signaling, whether ambient or not, including infra-red

The substitution of a consig_unit_transceiver with any other form of any other wireless interface or protocol, whether presently known or hereafter created

The substitution of a consig_unit_transceiver with any protocol or standard, whether wireless, wired or otherwise, including any combination of protocols or standards

The substitution of a consig_unit_transceiver with any protocol or standard, whether wireless, wired or otherwise, including any combination of protocols or standards sponsored, developed, proposed, promulgated and/or approved by any corporation, private consortium, the IEEE, ANSI, ISO or any other public or private standards groups

The substitution of any data communications protocol for any step, method, process or part of the communication of any data concerning any element or elements of this invention

### SUMMARY OF THE INVENTION

In accordance with a preferred embodiment of the invention, there is provided a Method of Making Music comprising:
1) a Played_Object, consisting of anything capable of being sensed by any method of sensing, whether natural, artificial, direct, or indirect, or any combination of the foregoing, including without limitation any natural or artificial thing or any combination of such things such as by way of example, but not limitation, anything designed, fabricated or assembled, any emulated, simulated or projected object, and anything capable by any means of being exhibited as a form of art, including any man-made, found, natural or modified object or anything which might consist of or include one or more forms of life, such as but not limited to the musician or musicians themselves, or any combination of any of the foregoing,
2) a Played_Object_Sensor, consisting of any kind of sensor associated with a Played_Object, whether or not attached to a Played_Object, including without limitation any sensor in, on, at, above, attached, adjacent, proximate, near or far from such Played-Object and further including without limitation any sensor logically associated with a Played_Object however physically remote from such Played-Object,
3) a Played_Object_Transmitter, consisting of any means for transmitting the state, signal and/or value of one or more Played_Object_Sensors,
4) a Consig_Unit, consisting of any means for controlling, synthesizing, splitting, muxing, filtering or otherwise processing the state, signal and/or value of one or more Played_Object_Sensors and communicating the same with one or more Played_Object(s), one or more Consig_Unit(s), or any combination thereof.

In a first preferred embodiment communication between a Played_Object_Transmitter and a Consig_Unit is wireless and networked.

Additionally, an optional element of this invention is a Listening_Unit, consisting of any means of listening and/or otherwise monitoring the raw and/or processed state, signal and/or values of one or more Played_Object_Sensors.

As can be seen by anyone skilled in the art, a Listening_Unit can be incorporated into another element of this invention or be a physically independent object which communicates with one or more other elements of this invention by any communication means.

In a first optional embodiment a Listening_Unit consists of a wireless ear bud or headset, such as a Bluetooth earpiece.

Alternative optional embodiments include by way of example, but not limitation, a wired ear bud or headset, a speaker, a visual indicator, a kinesthetic indicator such as force motion gyroscope or low current TENS muscle stimulator, a projected or virtual indicator or any combination of the foregoing.

In accordance with a preferred embodiment of the invention, there is provided a Method of Making Music comprising the steps of:
1) a Played_Object, consisting of anything capable of being sensed by any method of sensing, whether natural, artificial, direct, or indirect, or any combination of the foregoing, including without limitation any natural or artificial thing or any combination of such things such as by way of example, but not limitation, anything designed, fabricated or assembled, any emulated, simulated or projected object, and anything capable by any means of being exhibited as a form of art, including anything which might include one or more forms of life,
2) a Played_Object_Sensor, consisting of any kind of sensor associated with a Played_Object, whether or not attached to a Played_Object, including without limitation any sensor in, on, at, above, attached, adjacent, proximate, near or far from such Played-Object and further including without limitation any sensor logically associated with a Played_Object however physically remote from such Played-Object,
3) a Played_Object_Transmitter, consisting of any means for communicating the state, signal and/or value of one or more Played_Object_Sensors,
4) a Consig_Unit, consisting of any means for controlling, synthesizing, splitting, muxing, filtering or otherwise processing the state, signal and/or value of one or more Played_Object_Sensors and communicating the same with one or more Played_Object(s), one or more Consig_Unit(s), or any combination thereof, in which the steps of the method consist of the interaction between these elements.

In a first preferred embodiment the interaction would be controlled by one or more persons composing, playing and/or performing music by doing any physical act, mental act capable of physical sensation or a combination of the two, triggering one or more Played_Object_Sensor(s) and optionally modified by one or more Consig_Units.

In a first preferred embodiment communication between a Played_Object_Transmitter and a Consig_Unit is wireless and networked.

Additionally, an optional element of this invention is a Listening_Unit, consisting of any means of listening and/or otherwise monitoring the raw and/or processed state, signal and/or values of one or more Played_object_Sensors.

As can be seen by anyone skilled in the art, a Listening_Unit can be incorporated into another element of this invention or be a physically independent object which communicates with one or more other elements of this invention by any communication means.

In a first optional embodiment a Listening_Unit consists of a wireless ear bud or headset.

Alternative optional embodiments include by way of example, but not limitation, a wired ear bud or headset, a speaker, a visual indicator, a kinesthetic indicator such as force motion gyroscope or low current TENS muscle stimulator, a projected or virtual indicator or any combination [combation: typo] of the foregoing.

As an example, by way of illustration but not limitation, in a first illustrative embodiment a musician makes music by acting upon a portable Played_Object incorporating one or more Played_Object_Sensors which communicate with a portable Consig_Unit optionally communicating with a headset and optionally networked with others.

As an example, by way of illustration but not limitation, in a second illustrative embodiment a musician makes music by shaking, tapping, touching, blowing and/or otherwise manipulating a mobile phone device, optionally listening to the sound through an earbud, and optionally playing with another musician nearby or long distance.

In accordance with a preferred embodiment of the invention, there is provided an Apparatus for Making Music comprising: 1) a Played_Object, consisting of anything capable of being sensed by any method of sensing, whether natural, artificial, direct, or indirect, or any combination of the foregoing, including without limitation any natural or artificial thing or any combination of such things such as by way of example, but not limitation, anything designed, fabricated or assembled, any emulated, simulated or projected object, and anything capable by any means of being exhibited as a form of art, including anything which might include one or more forms of life, 2) a Played_Object_Sensor, consisting of any kind of sensor associated with a Played_Object, whether or not attached to a Played_Object, including without limitation any sensor in, on, at, above, attached, adjacent, proximate, near or far from such Played-Object and further including without limitation any sensor logically associated with a Played_Object however physically remote from such Played-Object, 3) a Played_Object_Transmitter, consisting of any means for transmitting the state, signal and/or value of one or more Played_Object_Sensors, 4) a Consig_Unit, consisting of any means for controlling, synthesizing, splitting, muxing, filtering or otherwise processing the state, signal and/or value of one or more Played_Object_Sensors and communicating the same with one or more Played_Object(s), one or more Consig_Unit(s), or any combination thereof. In a first preferred embodiment communication between a Played_Object_Transmitter and a Consig_Unit is wireless and networked. Additionally, an optional element of this invention is a Listening_Unit, consisting of any means of listening and/or otherwise monitoring the raw and/or processed state, signal and/or values of one or more Played_Object_Sensors. As can be seen by anyone skilled in the art, a Listening_Unit can be incorporated into another element of this invention or be a physically independent object which communicates with one or more other elements of this invention by any communication means. In a first optional embodiment a Listening_Unit consists of a wireless ear bud or headset. Alternative optional embodiments include by way of example, but not limitation, a wired ear bud or headset, a speaker, a visual indicator, a kinesthetic indicator such as force motion gyroscope or low current TENS muscle stimulator, a projected or virtual indicator or any combination of the foregoing. As an example, by way of illustration but not limitation, such an apparatus might consist of a mobile phone as Played_Object equipped with sensors detecting motion, touch or a change thereof, and communication of this data to a Consig_Unit in the phone, in the network or elsewhere such as a portable Consig_Unit, together with an optional Listening_Unit to hear or monitor the music so created.

In accordance with a preferred embodiment of the invention, there is provided An Article of Manufacture for making music comprising: 1) a Played_Object, consisting of anything capable of being sensed by any method of sensing, whether natural, artificial, direct, or indirect, or any combination of the foregoing, including without limitation any natural or artificial thing or any combination of such things such as by way of example, but not limitation, anything designed, fabricated or assembled, any emulated, simulated or projected object, and anything capable by any means of being exhibited as a form of art, including anything which might include one or more forms of life, 2) a Played_Object_Sensor, consisting of any kind of sensor associated with a Played_Object, whether or not attached to a Played_Object, including without limitation any sensor in, on, at, above, attached, adjacent, proximate, near or far from such Played-Object and further including without limitation any sensor logically associated with a Played_Object however physically remote from such Played-Object, 3) a Played_Object_Transmitter, consisting of any means for transmitting the state, signal and/or value of one or more Played_Object_Sensors, 4) a Consig_Unit, consisting of any means for controlling, synthesizing, splitting, muxing, filtering or otherwise processing the state, signal and/or value of one or more Played_Object_Sensors and communicating the same with one or more Played_Object(s), one or more Consig_Unit(s), or any combination thereof. In a first preferred embodiment communication between a Played_Object_Transmitter and a Consig_Unit is wireless and networked. Additionally, an optional element of this invention is a Listening_Unit, consisting of any means of listening and/or otherwise monitoring the raw and/or processed state, signal and/or values of one or more Played_Object_Sensors. As can be seen by anyone skilled in the art, a Listening_Unit can be incorporated into another element of this invention or be a physically independent object which communicates with one or more other elements of this invention by any communication means. In a first optional embodiment a Listening_Unit consists of a wireless ear bud or headset. Alternative optional embodiments include by way of example, but not limitation, a wired ear bud or headset, a speaker, a visual indicator, a kinesthetic indicator such as force motion gyroscope or low current TENS muscle stimulator, a projected or virtual indicator or any combination of the foregoing. As an example, by way of illustration but not limitation, such an article of manufacture might consist of a watch incorporating a Played_Object_Sensor sensing changes in position which communicates with a portable device, such as a by way of illustration a mobile phone, incorporating a Consig_Unit thus enabling the person, such as a dancer, wearing the watch to play solo or ensemble using their body as a Played_Object.

As can be appreciated by one skilled in the art, the invention herein can be used for the making of music for any reason, or combination of reasons that move people to make music including by way of illustration: entertainment, the performance of musical arts of any genre, the performance of any other art such as dance or theater, teaching, therapy, the playing of a game

### BRIEF DESCRIPTION OF THE DRAWINGS

A complete understanding of the present invention may be obtained by reference to the accompanying drawings, when considered in conjunction with the subsequent, detailed description.

For purposes of clarity and brevity, like elements and components will bear the same designations and numbering throughout the FIGURES.

### DESCRIPTION OF THE PREFERRED EMBODIMENT

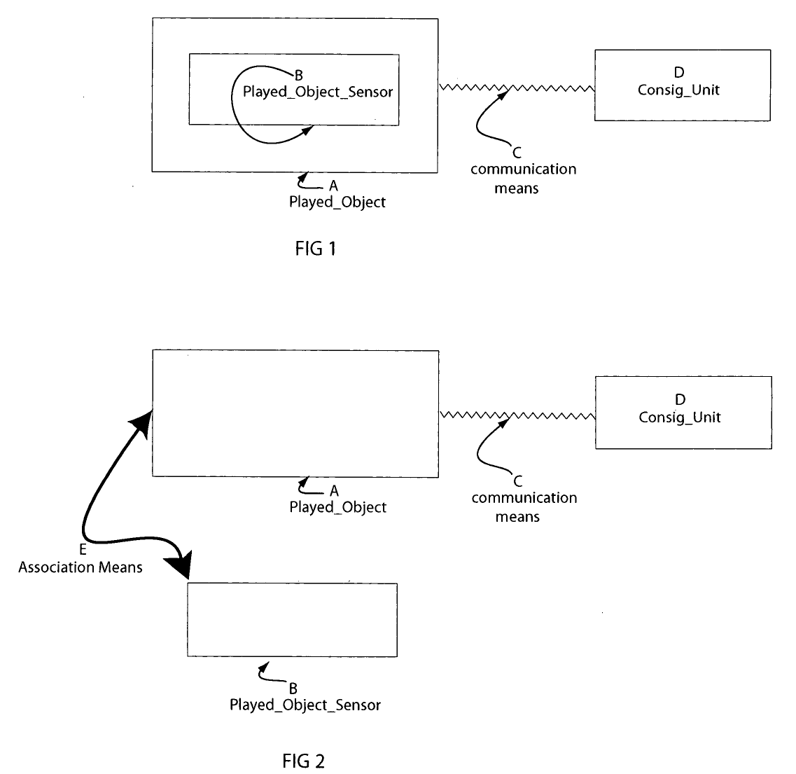

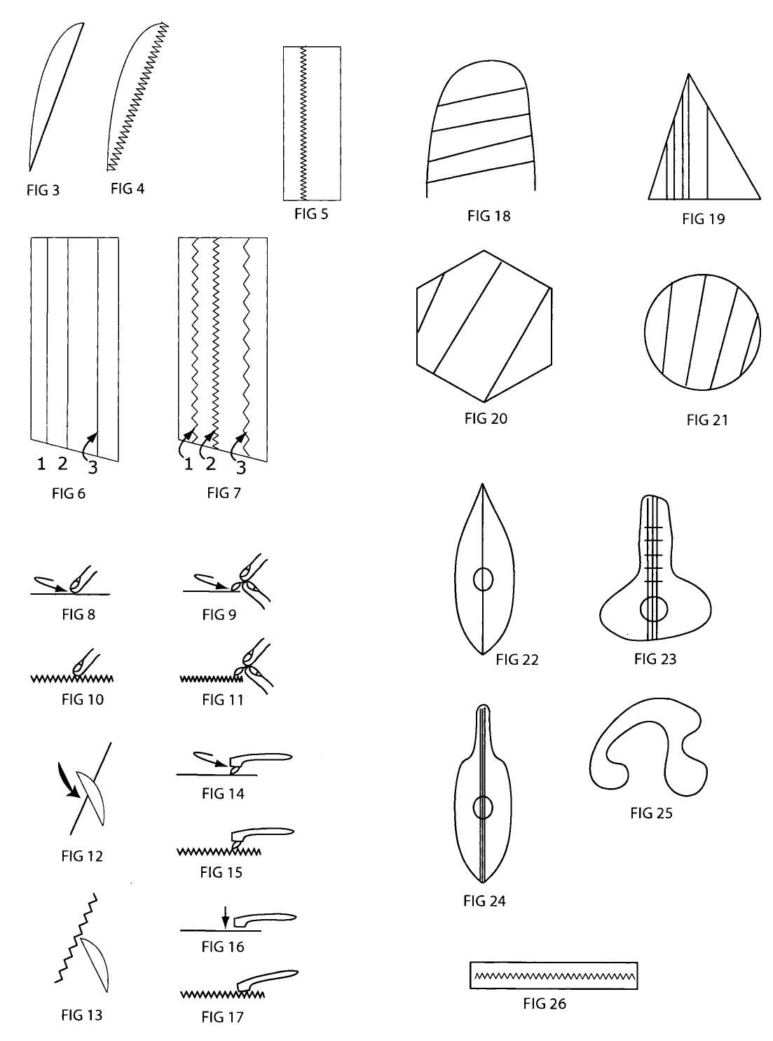

FIG. 1 is a functional view of a musical instrument consisting of item A, a Played_Object and incorporating item B, a Played_Object_Sensor.

The Played_Object may contain one or more Played_Object_Sensor(s).

Played_Object_Sensor(s) may be in any physical arrangement to the Played_Object, including without limitation, in, on, at, above, below, adjacent, near or otherwise proximate to the Played_Object.

A Played_Object_Sensor communicates, (as shown in Item C) by any communication means, with item D, a Consig_Unit.

A Consig_Unit may communicate with one or more Played_Object_Sensors.

Communication means include, but are not limited to, any wireless network, wireless bus, wireless link, wired link, wired bus or wired network. In the preferred embodiment the communication means is via a wireless network.

FIG. 2 shows a similar functional view of a musical instrument in which one or more Played_Object_Sensor(s) are remote from the Played_Object and associated with the Played_Object by any association mean.

Examples of an association means include, but are not limited to, any remote sensing method and any method of projecting or virtually emulating or simulating a Played_Object and sensing any physical characteristic so emulated or simulated. More specifically this includes, without limitation, detecting an actual or virtual Played_Object by any sensing means and logically associating or mapping one or more signals, levels, values or other information characteristics of a Played_Object_Sensor with a Played_Object.

An optional Listening_Unit may be used to listen to or otherwise monitor the signals, levels, values, output, input or other information from one or more Played_Object_Sensors. Such a Listening_Unit may communicate with Played_Object_Sensors by any communication means, including but not limited to, any wireless network, wireless bus, wireless link, wired network, wired bus or wired link. As examples, without limiting the foregoing, a Listening_Unit may be a speaker, ear bud, headset, visual indicator, or combination of the foregoing. A Listening_Unit may be in any physical arrangement to a Played_Object, Played_Object_Sensor or Config_Unit, including without limitation, in, on, at, above, below, adjacent, near or otherwise proximate or remote to the Played Object.

In the preferred embodiment a Consig_Unit is portable. In the preferred embodiment a Consig_Unit is a portable device small enough to fit in a pocket or wear on a belt clip. In such an embodiment the Consig_Unit constitutes a partionion of function wherein a sound generator or synthesizer is a wireless portable device that is physically separate from the Played_Object.

In an illustrative embodiment the Played_Object is a mobile phone, cell phone or personal handyphone and the Consig_Unit is either in the phone, a portable device that is physically separate from the phone or connect to the phone network.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Musical instruments that are sold today, and you can see this in any Guitar Center, similar musical store, the catalog of every major musical manufacturer and the tradeshows at NAMM, are all of historic forms, even when electrified, that originate from basic acoustics.

FIG. 3 show a simple bow. Pluck or stum it and it vibrates as shown in FIG. 4. Arrange a string in a frame as shown in FIG. 5, combine it with other strings of varying thicknesses as shown in FIG. 6 and pluck them as shown in FIG. 7 and you have one of the first kinds of historic musical instruments.

The origin of other instruments comes, from similar origins.

Touch a membrane or plate with your finger as shown in FIG. 8 or with another object as shown in FIG. 9 and you vibrate the membrane or plate (FIGS. 10 and 11).

Other physical shapes can be vibrated by other means.

Bow across a string as shown in FIG. 12 and it vibrates as shown in FIG. 13.

Pluck a string with a hammer as is done in the Harpsichord as shown in FIG. 14 and it vibrates as shown in FIG. 15.

Hammer a string as in a Piano as shown in FIG. 16 and it vibrates as shown in FIG. 17.

While it would be possible to create musical instruments in the forms shown in FIG. 18 through 21, the acoustic sounds of certain form predominated over time as shown in FIGS. 22, 23 and 24 for the Zither, Guitar and Lute respectively.

The form of all instruments is much more limited that what might be possible if the laws of acoustics did not restrict design, as can be seen in FIGS. 18, 29, 20, 21 and most particularly 25.

As can be seen by anyone skilled in the art, any form of vibrating physical material can be the substance of an acoustic instrument, for example the vibrating column shown in FIG. 26, but in all cases instruments have been constrained to forms dictated by acoustics, which limits their portability, ease of use, ergonomics and other aspects of their functional utility.

Having thus described the invention, what is desired to be protected by Letters Patent is presented in the subsequently appended claims.

1. A method for playing music comprising a sensing means communicating to a processing means other than a personal computer, wherein the sensing means and processing means are not contained within the same enclosure.

2. The claims of item 1 wherein any one or more of the elements are plural.

3. A method for playing music comprising a Played_Object_Sensor, a Played_Object_Transmitter and a Consig_Unit, wherein the Played_Object_Sensor is [are:typo] not contained within the same enclosure.

4. The claims of item 3 wherein any one or more of the elements are plural.

5. A method for making anything into a musical instrument comprising a sensing means communicating wirelessly with a processing means.

6. The claims of item 5 wherein any one or more of the elements are plural.

7. A method of making anything into a musical instrument comprising a Played_Object_Sensor, a Played_Object_Transmitter and a Consig_Unit, wherein the Played_Object_Sensor is [are:typo] not contained within the same enclosure.

8. The claims of item 7 wherein one or more of the elements are plural.

9. The claims of any of the foregoing items, wherein the played object is virtual, whether in whole or in part.

10. The claims of any of the foregoing items, wherein the played object is portable.

11. A method and apparatus for making music and article of manufacture thereof in which the Played_Object is capable of being in any form, whether physical or virtual and the sound is synthesized in a wireless portable device.

12. A method and apparatus for making music and article of manufacture thereof in which the Played_Object is capable of being in any form, whether physical or virtual and the sound is synthesis a portable device other than a notebook computer.

13. The claims of item 12 in which either the Played_Object or the Consig_Unit are selected from the group consisting of: mobile phone, cell phone, watch, any form of jewelry, any article of clothing including shoes or other apparel, any item of sports equipment, any plurality of elements in this list, any combination of elements in this list.
Without limiting the foregoing, these claims enable musical instruments that are more portable, ergonomic, visually attractive, fun and easier to play than musical instruments heretofore.
